(19) United States
(12) Patent Application Publication
(10) Pub. No.: US 2022/0186522 A1
(43) Pub. Date: Jun. 16, 2022

(54) DETACHABLE HANDLE

(71) Applicant: Aaron Clemons, Alpena, MI (US)

(72) Inventor: Aaron Clemons, Alpena, MI (US)

(21) Appl. No.: 17/123,282

(22) Filed: Dec. 16, 2020

(51) Int. Cl. E05B 1/00

(52) U.S. Cl. CPC E05B 1/0015

(57) ABSTRACT

A detachable handle, including a handle assembly, a friction surface disposed on at least a portion of a center portion of the handle assembly to facilitate gripping thereof, and a plurality of hooks, including a first hook movably disposed on at least a portion of a first end of the handle assembly to detachably connect to an external surface, and a second hook movably disposed on at least a portion of a second end of the handle assembly to detachably connect to the external surface.

### BACKGROUND

### 1. Field

The present general inventive concept relates generally to a handle, and particularly, to a detachable handle.

### 2. Description of the Related Art

Modern society has been changed with the rise of deadly pathogens. More recently, the world is confronting coronavirus disease 2019 (COVID-19) cased by severe acute respiratory syndrome coronavirus 2 (SARS-CoV-2). The COVID-19 global pandemic has only increased the importance of safety measures to prevent further spread. However, many activities still require a person to touch handles and other commonly used hardware to open doors that can unfortunately spread pathogens due to the frequency of use.

Although some changes have been made to opening doors, such as handles that don't require the use of hands, the person must still contact the door with a part of the body, such as the arm and/or elbow. As such, the person is exposed to potential pathogens from public use.

Therefore, there is a need for a detachable handle that is portable and connectable to a door and/or a door handle that does not require a user to touch the door handle used by the public.

### SUMMARY

The present general inventive concept provides a detachable handle.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a detachable handle, including a handle assembly, a friction surface disposed on at least a portion of a center portion of the handle assembly to facilitate gripping thereof, and a plurality of hooks, including a first hook movably disposed on at least a portion of a first end of the handle assembly to detachably connect to an external surface, and a second hook movably disposed on at least a portion of a second end of the handle assembly to detachably connect to the external surface.

The friction surface may be constructed of a thermal insulation material.

The thermal insulation material may be at least one of wood, mineral wool, fiberglass, polystyrene, cellulose, and polyurethane foam.

The first hook may be oriented in a first direction and the second hook is oriented in a second direction opposite with respect to the first direction.

The first hook and the second hook may pivot and rotate with respect to the handle assembly.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a detachable handle, according to an exemplary embodiment of the present general inventive concept; and

FIG. 2 illustrates a bottom perspective view of the detachable handle, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Detachable Handle 100
Handle Assembly 110
Grip Portion 111
Base 112
Friction Surface 120
Hooks 130
First Hook 131
Second Hook 132
Ball Joints 140
First Joint 141
Second Joint 142

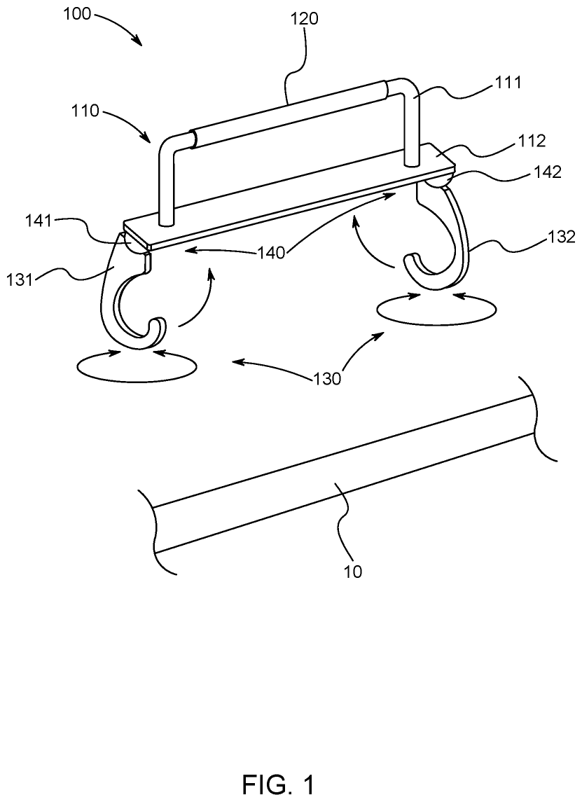

FIG. 1 illustrates a side perspective view of a detachable handle 100, according to an exemplary embodiment of the present general inventive concept.

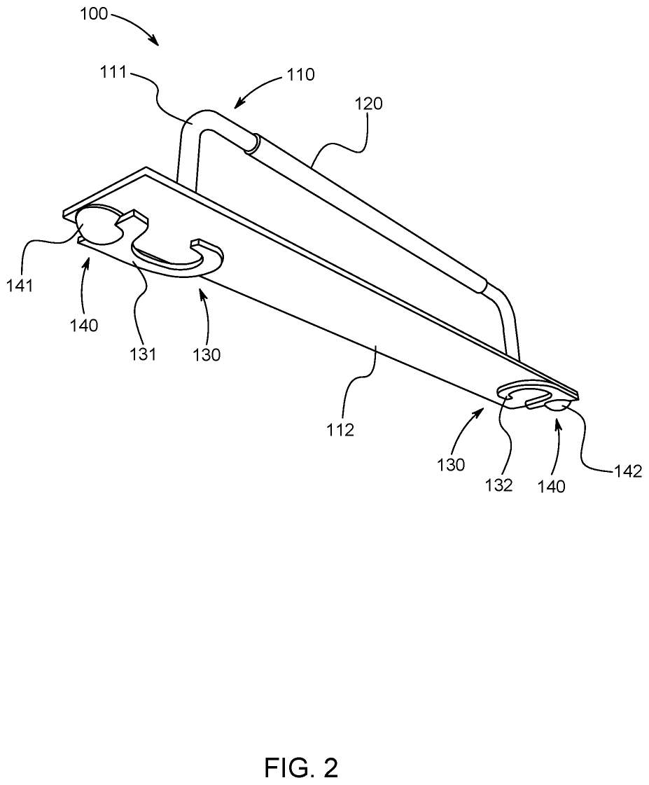

FIG. 2 illustrates a bottom perspective view of the detachable handle 100, according to an exemplary embodiment of the present general inventive concept.

The detachable handle 100 may be constructed from at least one of metal, plastic, wood, and rubber, etc., but is not limited thereto.

The detachable handle 100 may include a handle assembly 110, a friction surface 120, a plurality of hooks 130, and a plurality of ball joints 140, but is not limited thereto.

The handle assembly 110 may include a grip portion 111 and a base 112, but is not limited thereto.

Referring to FIGS. 1 and 2, the grip portion 111 is illustrated to have a cylindrical shape. However, the grip portion 111 may be a rectangular prism, circular, conical, triangular, pentagonal, hexagonal, heptagonal, octagonal, or any other shape known to one of ordinary skill in the art, but is not limited thereto.

The grip portion 111 may be perpendicularly disposed at a first end and a second end away from the base 112 with respect to a direction. Moreover, a center portion of the grip portion 111 may be perpendicularly disposed away from the first end and the second end between the first end and the second end. In other words, the grip portion 111 may form a U-shape with respect to the base 112.

The friction surface 120 may include a solid smooth surface, a bubbled surface having protrusions extending therefrom, a mesh, an adhesive, and/or a semi-adhesive surface, etc., but is not limited thereto.

The friction surface 120 may be disposed on at least a portion of the center portion of the grip portion 111. The friction surface 120 may facilitate gripping thereof. Additionally, the friction surface 120 may be constructed of a thermal insulation material, such as wood, mineral wool, fiberglass, polystyrene, cellulose, polyurethane foam, and/or any combination thereof. Therefore, the friction surface 120 may prevent cold and/or hot temperatures from developing during use.

The plurality of hooks 130 may include a first hook 131 and a second hook 132, but is not limited thereto.

Referring again to FIGS. 1 and 2, the first hook 131 may be movably (i.e. pivotally and/or rotatably) disposed on at least a portion of a first end of the base 112. Additionally, the first hook 131 may move in at least one lateral direction with respect to the base 112 (e.g., a curved portion of the first hook 112 is folded toward the base 112) and/or rotate in a first rotational direction (i.e. clockwise) or a second rotational direction (i.e. counterclockwise) with respect to the base 112.

Referring again to FIGS. 1 and 2, the second hook 132 may be movably (i.e. pivotally and/or rotatably) disposed on at least a portion of a second end of the base 112. Additionally, the second hook 132 may move in at least one lateral direction with respect to the base 112 (e.g., a curved portion of the second hook 112 is folded toward the base 112) and/or rotate in the first rotational direction or the second rotational direction with respect to the base 112.

Preferably, the first hook 131 may be oriented in a first direction and/or the second hook 132 may be oriented in a second direction opposite with respect to the first direction. In other words, the first hook 131 may face a different direction than the second hook 132. As such, the first hook 131 and/or the second hook 132 may face different directions to prevent slipping off an external surface 10 (e.g., a door handle) during use. Accordingly, the first hook 131 and/or the second hook 132 may detachably connect to the external surface 10.

Furthermore, the first hook 131 and/or the second hook 132 may be a magnet and/or magnetized to facilitate connecting to a ferromagnetic surface.

The plurality of ball joints 140 may include a first joint 141 and a second joint 142, but is not limited thereto.

The first joint 141 may be disposed on at least a portion of the first end of the base 112. Moreover, the first joint 141 may connect the first hook 141 to the base 112. Accordingly, the first joint 141 may facilitate movement of the first hook 131. As such, the first hook 131 may move due to the first joint 141. Also, the first joint 141 may stop at predetermined positions. For example, referring to FIG. 2, the first hook 131 may lock position at a first forty-five degree position away from the base 112, a ninety-degree position away from the base 112 as illustrated in FIG. 1, a second forty-five degree position away from the base 112 opposite with respect to the first forty-five degree position, and a one-hundred eighty degree position away from the base 112 opposite with respect to the position as shown in FIG. 2. Accordingly, the first joint 141 may allow fixed positions of the first hook 131.

The second joint 142 may be disposed on at least a portion of the second end of the base 112. Moreover, the second joint 142 may connect the second hook 142 to the base 112. Accordingly, the second joint 142 may facilitate movement of the second hook 132. As such, the second hook 132 may move due to the second joint 142. Also, the second joint 142 may stop at predetermined positions. For example, referring to FIG. 2, the second hook 132 may lock position at a first forty-five degree position away from the base 112, a ninety-degree position away from the base 112 as illustrated in FIG. 1, a second forty-five degree position away from the base 112 opposite with respect to the first forty-five degree position, and a one-hundred eighty degree position away from the base 112 opposite with respect to the position as shown in FIG. 2. Accordingly, the second joint 142 may allow fixed positions of the second hook 132.

Therefore, the detachable handle 100 may be a portable solution for the user, such that the user may avoid using the external surface 10 used by a public community.

The present general inventive concept may include a detachable handle 100, including a handle assembly 110, a friction surface 120 disposed on at least a portion of a center portion of the handle assembly 110 to facilitate gripping thereof, and a plurality of hooks 130, including a first hook 131 movably disposed on at least a portion of a first end of the handle assembly 110 to detachably connect to an external surface 10, and a second hook 132 movably disposed on at least a portion of a second end of the handle assembly 110 to detachably connect to the external surface 10.

The friction surface 120 may be constructed of a thermal insulation material.

The thermal insulation material may be at least one of wood, mineral wool, fiberglass, polystyrene, cellulose, and polyurethane foam.

The first hook 131 may be oriented in a first direction and the second hook 132 is oriented in a second direction opposite with respect to the first direction.

The first hook 131 and the second hook 132 may pivot and rotate with respect to the handle assembly 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A detachable handle, comprising:
a handle assembly, comprising:
a base, and
a grip portion having a U-shape and perpendicularly disposed at a first end and a second end away from the base;
a friction surface disposed on at least a portion of a center portion of the grip portion to facilitate gripping thereof; and
a plurality of hooks, comprising:
a first hook movably disposed on at least a portion of a first end of the base to detachably connect to an external surface, and
a second hook movably disposed on at least a portion of a second end of the base to detachably connect to the external surface.

2. The detachable handle of claim 1, wherein the friction surface is constructed of a thermal insulation material.

3. The detachable handle of claim 2, wherein the thermal insulation material is at least one of wood, mineral wool, fiberglass, polystyrene, cellulose, and polyurethane foam.

4. The detachable handle of claim 1, wherein the first hook is oriented in a first direction and the second hook is oriented in a second direction opposite with respect to the first direction.

5. The detachable handle of claim 1, wherein the first hook and the second hook pivot and rotate with respect to the handle assembly.

6. A detachable handle, comprising:
a handle assembly;
a friction surface disposed on at least a portion of a center portion of the handle assembly to facilitate gripping thereof;
a plurality of hooks, comprising:
a first hook movably disposed on at least a portion of a first end of the handle assembly to detachably connect to an external surface, and
a second hook movably disposed on at least a portion of a second end of the handle assembly to detachably connect to the external surface;
a first ball joint disposed on a first end of the handle assembly between the handle assembly and the first hook to facilitate movement of the first hook, such that the first ball joint may stop movement at predetermined positions; and
a second ball joint disposed on a second end of the handle assembly between the handle assembly and the second hook to facilitate movement of the second hook, such that the second ball joint may stop movement at the predetermined positions.
